(19) United States
(12) Patent Application Publication
(10) Pub. No.: US 2013/0038706 A1
(43) Pub. Date: Feb. 14, 2013

(54) IMAGE DISPLAY SYSTEM, DISPLAY APPARATUS, AND SHUTTER GLASSES

(71) Applicant: Toru Nagara, Tokyo (JP)

(72) Inventor: Toru Nagara, Tokyo (JP)

(73) Assignee: Sony Corporation, Tokyo (JP)

(21) Appl. No.: 13/642,335

(22) PCT Filed: Feb. 1, 2012
(86) PCT No.: PCT/JP2012/052248

§ 371 Date: Oct. 19, 2012

(30) Foreign Application Priority Data
Feb. 28, 2011 (JP) 2011-41542

(51) Int. Cl. H04N 13/04

(52) U.S. Cl. 348/56; 348/E13.059

(57) ABSTRACT

The frequencies and the phases of frame timing signals are synchronized between a display apparatus and shutter glasses through a wireless network.

The display apparatus counts a frame period and a period until the frame timing signal transitions next time after a beacon transmission timing using a TSF clock and transmits a synchronization packet in which these periods are described. On a shutter glasses side, when the synchronization packet has been received, the frequencies are synchronized on the basis of a difference between frame periods measured by both of them. In addition, phase control is performed on the basis of a difference between periods until next frame timing signals after a beacon is transmitted, which are measured by both of them.

### TECHNICAL FIELD

The present invention relates to an image display system that is configured by a combination between a display apparatus that displays a plurality of images that are different from one another in time division and shutter glasses worn by a viewer of the images and that provides a stereoscopic image for the viewer by opening and closing left and right shutter lenses of the shutter glasses in synchronization with switching of the images on the display apparatus side, the display apparatus, and the shutter glasses, and, more particularly, relates to an image display system that controls the open and close timing of shutter lenses while a display apparatus and shutter glasses communicate with each other, the display apparatus, and the shutter glasses.

### BACKGROUND ART

By displaying images having parallax for left and right eyes, a stereoscopic image that looks stereoscopic to a viewer can be provided. As a method for providing a stereoscopic image, a method is used in which the viewer wears glasses having special optical characteristics and images having parallax are provided for the viewer's eyes.

For example, a time-division stereoscopic image display system is configured by a combination between a display apparatus that displays a plurality of images that are different from one another in time division and shutter glasses worn by a viewer of the images. The display apparatus alternately displays an image for the left eye and an image for the right eye on a screen in an extremely short period. On the other hand, the shutter glasses worn by the viewer has a shutter mechanism configured by a liquid crystal lens in each of a left eye portion and a right eye portion. In the shutter glasses, while the image for the left eye is displayed, the left eye portion of the shutter glasses propagates light and the right eye portion blocks light. In addition, while the image for the right eye is displayed, the right eye portion of the shutter glasses propagates light and the left eye portion blocks light (for example, refer to PTLs 1 to 3). That is, the shutter glasses select an image using the shutter mechanisms in synchronization with the time-division display of the image for the left eye and the image for the right eye by the display apparatus and the switching of the display by the display apparatus, and accordingly a stereoscopic image is provided for a viewing user.

In the time-division stereoscopic image display system, the image for the left eye and the image for the right eye need to be separated when the image for the left eye and the image for the right eye are displayed in time division, so that crosstalk is not generated. Therefore, the shutter glasses need to execute open and close switching of the left and right shutter lenses in synchronization with the switching timing of the image for the left eye and the image for the right eye on the display apparatus side.

As means of communication from the display apparatus to the shutter glasses, infrared communication or a wireless network such as Wi-Fi (Wireless Fidelity) or IEEE 802.15.4 can be utilized.

Here, when the open and close switching timing of the shutter lenses is transmitted using infrared communication, because a transmitted signal reaches the shutter glasses without delay, the open and close operation of the left and right shutter lenses on the shutter glasses side may be performed on the basis of the transmitted signal while following the transmitted signal. However, since an infrared signal has directivity, there is a problem in that synchronization can be established only when a user who wears the shutter glasses faces the front of the display apparatus (an infrared transmission unit). In addition, a light receiving surface for an infrared signal must be provided in a front surface of the shutter glasses, which restricts design. In addition, when a plurality of display apparatuses are arranged close to one another, an IR signal from an adjacent display apparatus might be received and the open and close timing of the shutter lenses might be incorrect.

On the other hand, since a wireless network does not have directivity, a user who wears the shutter glasses can receive a signal from a display apparatus at a desired position and there is no restriction in terms of design. In addition, because the wireless network can identify itself using a Service Set ID (SSID), even when a plurality of display apparatuses are located close to one another, the shutter glasses do not malfunction due to a signal received from another display apparatus. Moreover, a wireless network is bidirectional communication, and therefore data communication from the shutter glasses to the display apparatus is possible. For example, in the Japanese Patent Application No. 2009-276948 specification, which has already been transferred to the present applicant, a time-division stereoscopic image display system that utilizes a wireless network is disclosed.

Here, in the wireless network, there is a problem of signal interference, and therefore transmission of a packet can not necessarily begin at a predetermined time due to a collision avoidance procedure represented by CSMA/CA (Carrier Sense Multiple Access/Collision Avoidance). In addition, when a packet has been lost due to a cause such as interference from an adjacent system, a retransmission procedure starts, and therefore the packet can not necessarily be received by a destination at an expected time.

When a wireless network is applied to a time-division stereoscopic image display system, the time at which a packet arrives cannot be assured as described above if the open and close switching timing of the shutter lenses itself is attempted to be transmitted from the display apparatus to the shutter glasses using packet communication, and, as a result, synchronization between the switching of the images and the opening and closing of the shutter lenses cannot be established.

### CITATION LIST

### Patent Literature

PTL 1: Japanese Unexamined Patent Application Publication No. 9-138384
PTL 2: Japanese Unexamined Patent Application Publication No. 2000-36969
PTL 3: Japanese Unexamined Patent Application Publication No. 2003-45343

### SUMMARY OF INVENTION

### Technical Problem

An object of the present invention is to provide an excellent image display system, a display apparatus, and shutter glasses that can synchronize the open and close timing of shutter lenses with the switching of images and that can appropriately provide a stereoscopic image for a viewer who wears the shutter glasses.

Another object of the present invention is to provide an excellent image display system, a display apparatus, and shutter glasses that can synchronize the open and close timing of shutter lenses with the switching of images between the display apparatus and the shutter glasses that communicate with each other through a wireless network and that can appropriately provide a stereoscopic image for a viewer who wears the shutter glasses.

### Solution to Problem

The present application has been made while taking into consideration the above problem, and an invention described in claim 1 is an image display system including a display apparatus that includes a first communication unit which operates as an access point in a wireless network and executes packet communication and that displays an image for a left eye and an image for a right eye in time division on the basis of a first frame synchronization signal, and shutter glasses that includes a second communication unit which operates as a terminal station under the access point in the wireless network and executes packet communication, a signal generation unit which generates a second frame synchronization signal, left and right shutter lenses, and a driving control unit which executes driving control on an open and close operation of the left and right shutter lenses on the basis of the second frame synchronization signal. A system clock is shared between the first communication unit and the second communication unit using a TSF. The first communication unit transmits a beacon in a certain beacon period and also transmits a synchronization packet in which information for frequency synchronization and information for phase synchronization configured by values counted on the basis of the system clock are described. The shutter lenses synchronize the second frame synchronization signal with a frequency of the first frame synchronization signal on the basis of the information for the frequency synchronization described in the received synchronization packet and also synchronizes the second frame synchronization signal with a phase of the first frame synchronization signal on the basis of the information for the phase synchronization.

However, the “system” herein refers to an object in which a plurality of apparatuses (or function modules that realize particular functions) are logically collected, and whether or not each apparatus or module is included in a single chassis does not matter.

In addition, an invention described in claim 2 of the present application is a display apparatus including a display unit, an image signal processing unit that processes an image signal, a timing control unit that generates a frame synchronization signal for controlling a timing at which the image signal is displayed on a screen by the display unit, and a communication unit that operates as an access point in a wireless network and that executes packet communication. The communication unit transmits a beacon in a certain beacon period and shares a system clock with a terminal station thereunder using a TSF. The communication unit transmits a synchronization packet in which information for frequency synchronization and information for phase synchronization, which are used to synchronize the frame synchronization signal, configured by values counted on the basis of the system clock are described.

According to an invention described in claim 3 of the present application, the information for the frequency synchronization described in the synchronization packet transmitted by the display apparatus according to claim 2 is a count value obtained by counting a period of the frame synchronization signal using the system clock. In addition, the information for the phase synchronization is a count value obtained by counting a period until the frame synchronization signal transitions next time after a beacon transmission timing using the system clock.

In addition, an invention described in claim 4 of the present application is shutter glasses including left and right shutter lenses, a signal generation unit that generates a frame synchronization signal, a synchronization processing unit that synchronizes the frame synchronization signal, a driving control unit that executes driving control on an open and close operation of the left and right shutter lenses on the basis of the frame synchronization signal, and a communication unit that operates as a terminal station under an access point in a wireless network and that executes packet communication. The communication unit receives a beacon transmitted from the access point in a certain beacon period and shares a system clock with the access point using a TSF. A synchronization packet in which information for frequency synchronization and information for phase synchronization, which are used to synchronize frame synchronization signals in relation to a display apparatus that displays an image for a left eye and an image for a right eye on the basis of a frame synchronization signal, configured by values counted on the basis of the system clock are described is received by the communication unit. The synchronization processing unit synchronizes frequencies of the frame synchronization signals on the basis of the information for the frequency synchronization described in the synchronization packet and also synchronizes phases of the frame synchronization signals on the basis of the information for the phase synchronization.

According to an invention described in claim 5 of the present application, the information for the frequency synchronization described in the synchronization packet received by the shutter glasses according to claim 4 is a count value obtained by counting a period of the frame synchronization signal on a display apparatus side using the system clock. In addition, the synchronization processing unit is configured to count a period of the frame synchronization signal generated by the signal generation unit using the system clock and synchronize the frequencies using a difference from the count value of the information for the frequency synchronization as a frequency error value.

According to an invention described in claim 6 of the present application, the information for the phase synchronization described in the synchronization packet received by the shutter glasses according to claim 4 is a count value obtained by counting a period until the frame synchronization signal transitions next time after a beacon transmission timing on a display apparatus side using the system clock. In addition, the synchronization processing unit is configured to count a period until the frame synchronization signal generated by the signal generation unit transitions next time after a beacon reception timing of the communication unit using the system clock and synchronize the phases using a difference from the count value of the information for the phase synchronization as a phase error value.

### Advantageous Effects of Invention

According to the present invention, it is possible to provide an excellent image display system, a display apparatus, and shutter glasses that can synchronize the open and close timing of shutter lenses with the switching of images between the display apparatus and the shutter glasses that communicate with each other through a wireless network and that can appropriately provide a stereoscopic image for a viewer who wears the shutter glasses.

According to the present invention, since a frame synchronization signal in the display apparatus is generated on the shutter glasses side and synchronization of the frequencies and the phases of frame synchronization signals is accurately realized without using a packet transmission timing from the display apparatus, it is possible to provide a stereoscopic image with no crosstalk for a viewer who wears the shutter glasses.

Other objects, characteristics, and advantages of the present invention will be clarified by an embodiment of the present invention and more detailed description based on the accompanying drawings, which will be described later.

### BRIEF DESCRIPTION OF DRAWINGS

FIG. 1 is a diagram schematically illustrating an example of the configuration of an image display system.

FIG. 2 is a diagram illustrating an example of the internal configuration of a display apparatus 11.

FIG. 3 is a diagram illustrating an example of the internal configuration of shutter glasses 13.

FIG. 4A is a diagram illustrating a control operation of shutter lenses 308 and 209 of the shutter glasses 13 synchronized with a display period of an image L for a left eye of the display apparatus 11.

FIG. 4B is a diagram illustrating a control operation of shutter lenses 308 and 209 of the shutter glasses 13 synchronized with a display period of an image R for a right eye of the display apparatus 11.

FIG. 5 is a diagram illustrating an example of the configuration of a circuit that synchronizes the frequencies and the phases of frame synchronization signals.

FIG. 6 is a diagram illustrating the transfer characteristics of a control system that controls the frequency synchronization of a VCO in a signal generation unit 310 using a frequency comparator.

FIG. 7 is a diagram illustrating the transfer characteristics of a control system that controls the frequency synchronization of the VCO (described above) in the signal generation unit 310 using a phase comparator.

FIG. 8 is a diagram illustrating the transfer characteristics of a control system that controls the frequency synchronization of the VCO (described above) in the signal generation unit 310 using the frequency comparator and the phase comparator.

FIG. 9 is a diagram illustrating an example of the internal configuration of the shutter glasses 13.

### DESCRIPTION OF EMBODIMENT

An embodiment of the present invention will be described in detail hereinafter with reference to the drawings.

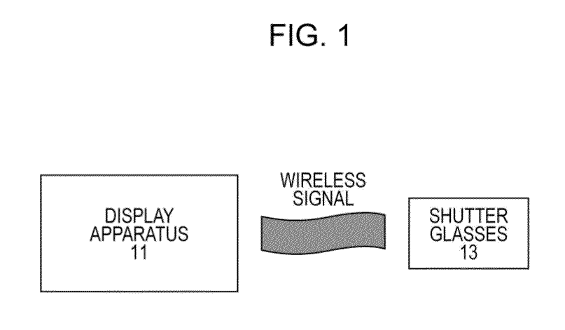

In FIG. 1, an example of the configuration of an image display system is schematically illustrated. The image display system is configured by a combination between a display apparatus 11 compatible with three-dimensional display (stereoscopic vision) and shutter glasses 13 having a shutter mechanism in each of a left eye portion and a right eye portion.

As the display apparatus 11 used for stereoscopic image display, a liquid crystal display (LCD) is used. The liquid crystal display is generally of an active matrix type in which a TFT (Thin Film Transistor) is provided for each pixel. A TFT liquid crystal display apparatus drives each pixel by writing an image signal for each scan line from an upper part of a screen to a lower part, and realizes display by blocking or propagating illuminating light from backlight using each pixel. However, the scope of the present invention is not limited to a particular method. For example, a plasma display panel (PDP) and an electroluminescence (EL) panel may be used as well as an existing CRT (Cathode Ray Tube) display.

When the display apparatus 11 displays an image for stereoscopic vision and a user who wears the shutter glasses 13 stereoscopically views the displayed image, the shutter glasses 13 need to execute open and close switching of left and right shutter lenses 308 and 309 in synchronization with the switching timing of an image for a left eye and an image for a right eye on a display apparatus 11 side.

For communication between the display apparatus 11 and the shutter glasses 13, a wireless network adopting radio wave communication, such as Wi-Fi or IEEE 802.15.4, is used. In the example of the system configuration illustrated in FIG. 1, the display apparatus 11 and the shutter glasses 13 execute one-to-one communication, but it is possible for the display apparatus 11 to operate as an access point and to store a plurality of shutter glasses, each of which operates as a terminal station. Because the wireless network is interactive communication, data communication from the shutter glasses 13 to the display apparatus 11 is also possible, and services that can be provided by the system can be expanded. It is to be noted that an image display system that utilizes the wireless network is, for example, disclosed in Japanese Patent Application No. 2009-276948, which has already been transferred to the present applicant.

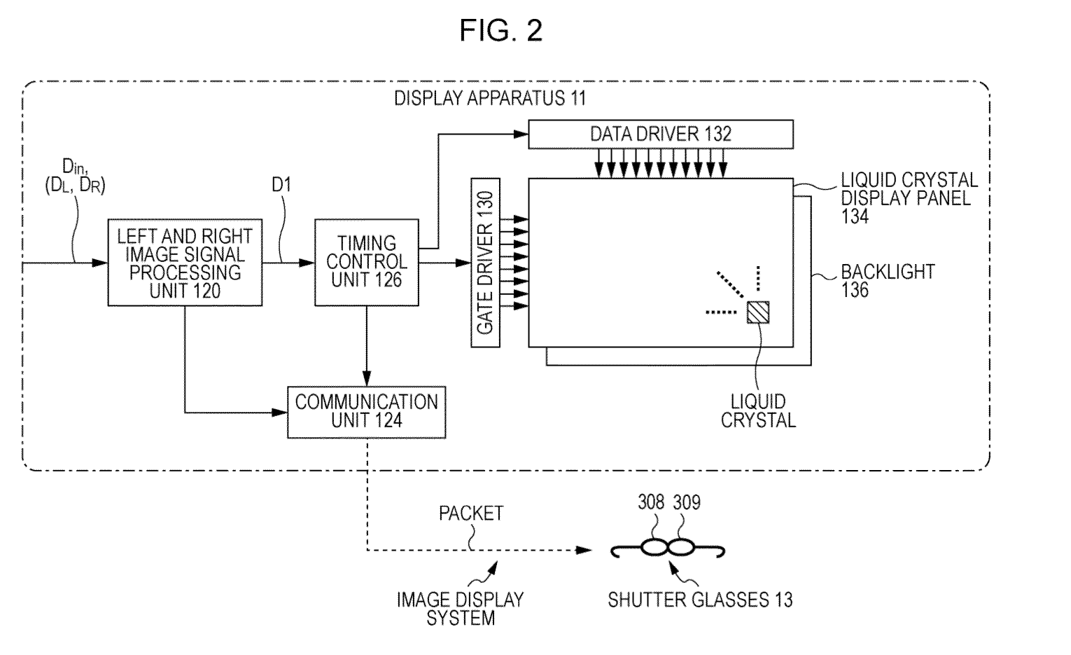

In FIG. 2, an example of the internal configuration of the display apparatus 11 is illustrated. Each component will be described hereinafter.

The display apparatus 11 includes a left and right image signal processing unit 120, a communication unit 124, a timing control unit 126, a gate driver 130, a data driver 132, and a liquid crystal display panel 134.

The liquid crystal display panel 134 includes a liquid crystal layer, transparent electrodes that face each other on either side of the liquid crystal layer, a color filter, and the like (all these components are not illustrated). In addition, on the back of the liquid crystal display panel 134, a backlight (planar light source) 136 is provided. The backlight 136 is configured by an LED (Light Emitting Diode) having good decay characteristics or the like.

An input signal Dᵢₙ, which includes left and right image signals D_{L} and D_{R} for displaying an image L for the left eye and an image R for the right eye, respectively, is input to the left and right image signal processing unit 120. In order for the liquid crystal display panel 134 to alternately display the image L for the left eye and the image R for the right eye, the left and right image signal processing unit 120 alternately outputs the left and right image signals D_{L} and D_{R}.

The image signal D_{L} for the left eye and the image signal D_{R} for the right eye converted by the left and right image signal processing unit 120 are input to the timing control unit 126. The timing control unit 126 converts the image signal D_{L} for the left eye and the image signal D_{R} for the right eye that have been input thereto into signals to be input to the liquid crystal display panel 134, as well as generating pulse signals to be used for the operation of the gate driver 130 and the data driver 132. More specifically, the pulse signals herein are a vertical synchronization signal (VSYNC) and a horizontal synchronization signal (HSYNC). In addition, the timing control unit 126 inputs the VSYNC, which is a frame synchronization signal, to the communication unit 124. When the frame period of a displayed image is 60 Hz, the frame synchronization signal is a pulse signal having a period of 16.6 milliseconds.

The gate driver 130 and the data driver 132 receive the pulse signals (the VSYNC and the HSYNC) generated by the timing control unit 126 and cause each pixel of the liquid crystal display panel 134 to turn on the basis of the input signals. Thus, an image is displayed on the liquid crystal display panel 134.

The communication unit 124 operates as an access point in the wireless network such as Wi-Fi or IEEE 802.15.4, stores one or more pairs of shutter glasses 13 that operate as terminal stations in a basic service set (BSS) thereof, and regularly (normally in a period of 100 milliseconds) transmits beacons. In addition, the communication unit 124 transmits a data packet to the shutter glasses 13, as well as being able to receive a data packet from the shutter glasses 13.

In a wireless network according to a standard specification such as Wi-Fi or IEEE 802.15.4, it is known that synchronization of system clocks is accurately established using a TSF (Timing Synchronization Function). That is, a TSF timer value is described in a beacon transmitted from the communication unit 124, and synchronization of TSF clocks can be established with shutter glasses 13 that have received the beacon. The TSF clocks correspond to the system clocks in the wireless network, and although a synchronization accuracy of 250 microseconds is specified, currently an accuracy equal to or higher than this specified value is obtained in products on the market.

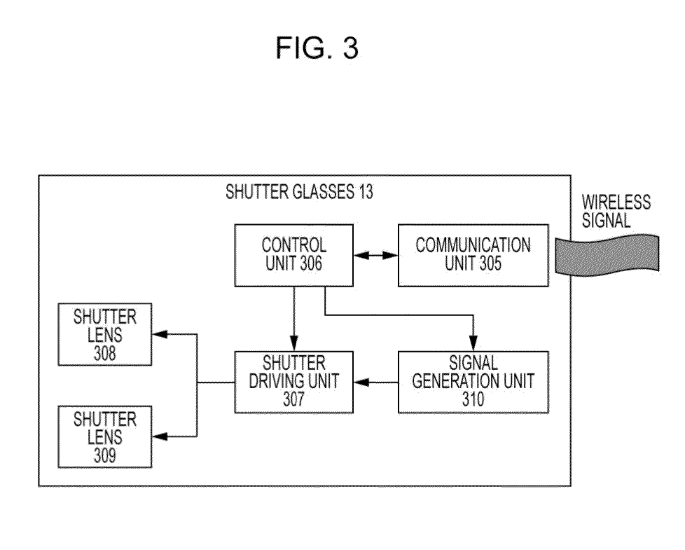

In FIG. 3, an example of the internal configuration of the shutter glasses 13 is illustrated. The shutter glasses 13 include a communication unit 305 that transmits and receives wireless signals to and from the display apparatus 11 using radio wave communication, a control unit 306, a shutter lens 308 for the left eye and a shutter lens 309 for the right eye, each of which is composed of a liquid crystal material, a shutter driving unit 307, and a signal generation unit 310.

The communication unit 305 operates as a terminal station under an access point in the wireless network specified by Wi-Fi or IEEE 802.15.4. The communication unit 124 in the display apparatus 11 operates as an access point and wirelessly transmits packets such as a beacon and a data packet to the shutter glasses 13 thereunder (that is, stored in the BSS) (described above). Upon receiving these packets, the communication unit 305 inputs the packets to the control unit 306.

Upon receiving a beacon, the control unit 306 controls the operation of the communication unit 305 on the basis of the content of description of the beacon and is stored in the BSS of the access point (the communication unit 124 on the display apparatus 11 side). In addition, the control unit 306 accurately synchronizes with the system clocks on the basis of the TSF timer value described in the beacon (described above).

The signal generation unit 310 includes a mechanism (not illustrated) that executes PLL (Phase Lock Loop) control on a VCO (Voltage Controlled Oscillator), and the liquid crystal display panel 134 on the display apparatus 11 side generates a frame synchronization signal indicating switching between the image for the left eye and the image for the right eye. When the frame period of a displayed image is 60 Hz, the frame synchronization signal is a pulse signal having a period of 16.6 milliseconds.

The shutter driving unit 307 executes driving control on the open and close operation of the left and right shutter lenses 308 and 309 on the basis of the frame synchronization signal generated by the signal generation unit 310.

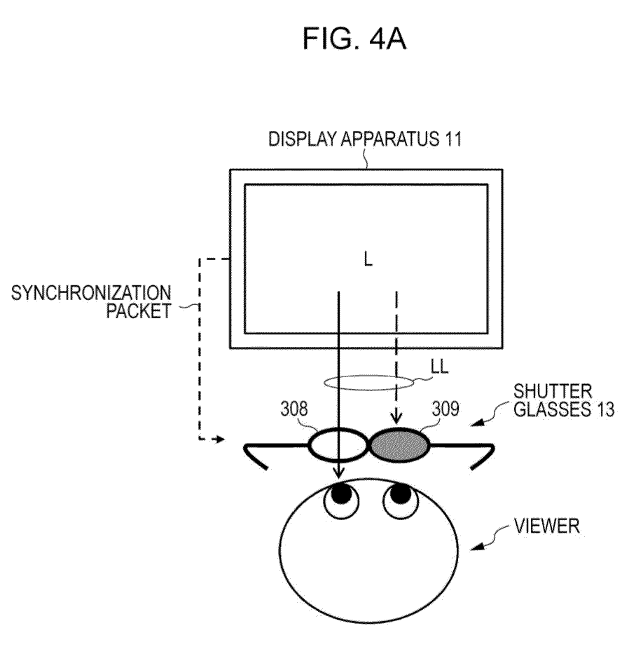

In FIG. 4A, a control operation performed on the shutter lenses 308 and 309 of the shutter glasses 13 in synchronization with a period for which the image L for the left eye is displayed on the display apparatus 11 is illustrated. As illustrated in the figure, in the period for which the image L for the left eye is displayed, the shutter lens 308 for the left eye opens and the shutter lens 309 for the right eye closes in accordance with a synchronization packet wirelessly transmitted from the display apparatus 11 side, and display light LL based on the image L for the left eye reaches only the user's left eye.

In addition, in FIG. 4B, a control operation performed on the shutter lenses 308 and 309 of the shutter glasses 13 in synchronization with a period for which the image R for the right eye is displayed is illustrated. As illustrated in the figure, in the period for which the image R for the right eye is displayed, the shutter lens 309 for the right eye opens and the shutter lens 308 for the left eye closes, and display light RR based on the image R for the right eye reaches only the user's right eye.

The display apparatus 11 alternately displays the image L for the left eye and the image R for the right eye on the liquid crystal display panel 134 for each field. On a shutter glasses 13 side, the left and right shutter lenses 308 and 309 alternately execute the open and close operation in synchronization with the switching of the images in each field of the display apparatus 11. The user who views the displayed images through the shutter glasses 13 stereoscopically recognizes the images displayed on the display apparatus 11 since the image L for the left eye and the image R for the right eye are combined.

It is to be noted that the shutter glasses 13 drive using a battery (not illustrated) as a main power supply. Every time the capacity of the battery decreases, the battery needs to be replaced or charged. The communication unit 305 is configured to execute an intermittent reception operation, so that power is not wasted to receive signals.

The wireless network has a problem of signal interference, and transmission of packets can not necessarily begin at a predetermined time due to a collision avoidance procedure represented by CSMA/CA. In addition, when a packet has been lost due to a cause such as interference from an adjacent system, a retransmission procedure starts, and the packet does not necessarily reaches a destination at an expected time.

Therefore, even if the open and close switching timing of the shutter lenses itself is attempted to be transmitted from the display apparatus 11 to the shutter glasses 13 using packet communication, the arrival time of a packet cannot be assured as described above, and therefore the switching of the images and the opening and closing of the shutter lenses cannot be synchronized with each other.

On the other hand, in the image display system according to this embodiment, as described above, a frame synchronization signal is generated on the shutter glasses 13 side, and the open and close switching of the shutter lenses is performed on the basis of the frame synchronization signal generated by the shutter glasses 13 themselves. In addition, the display apparatus 11 transmits, to the shutter glasses 13, not the open and close switching timing of the shutter lenses but a synchronization packet for establishing synchronization of the frame synchronization signals. Thereafter, on the shutter glasses 13 side, the frequencies and the phases of the frame synchronization signals are synchronized on the basis of the content of description of the received synchronization packet. However, retransmission of the synchronization packet is not performed.

Thus, since the synchronization of the frequencies and the phases of the frame synchronization signals is accurately realized on the shutter glasses 13 without using the packet transmission timing from the display apparatus 11 at all, the effect of transmission delay can be reduced. In addition, since the open and close switching of the shutter lenses 308 and 309 is performed on the basis of the frame timing in which the frequencies and the phases are accurately synchronized, crosstalk is not generated for the user views a stereoscopic image using the shutter glasses 13.

A method for synchronizing the frequencies and the phases of the frame synchronization signals on the shutter glasses 13 side on the basis of the synchronization packet transmitted from the display apparatus 11 will be described in detail hereinafter.

Here, on the transmission side (that is, the communication unit 124 of the display apparatus 11) and on the reception side (that is, the communication unit 305 of the shutter glasses 13), the TSF is used as the timing. The TSF is a clock (known) used to control the transmission and reception timing of packets in a wireless network, and the control of the timing is performed in units of microseconds (although a specified value of 250 microseconds or shorter is specified, currently an accuracy equal to or higher than this specified value is obtained in products on the market) (described above).

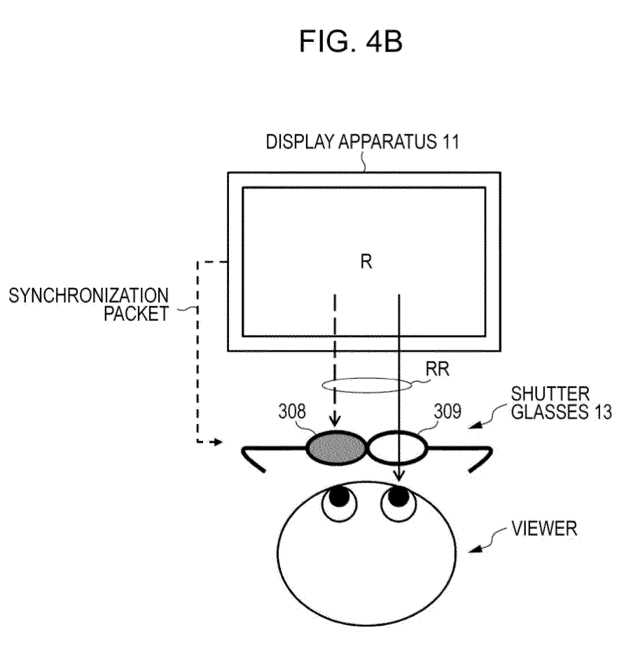

In FIG. 5, an example of the configuration of a circuit that synchronizes the frequencies and the phases of the frame synchronization signals is illustrated. The frequency synchronization and the phase synchronization are separately considered. The frequency synchronization is performed by comparing frame frequencies measured using TSF clocks. That is, the periods of the frame synchronization signals (in this embodiment, the VSYNCs) are counted using the TSF clocks in the display apparatus 11 and the shutter glasses 13. In addition, when the frame period of a displayed image is 60 Hz, the periods of the frame synchronization signals are 16.6 milliseconds. In addition, the periods of the TSF clocks are 1 microsecond, and the allowable error is ±5000 ppm.

As described above, on the display apparatus 11 side, the frame synchronization signal generated by the timing control unit 126 is input to the communication unit 124, and the communication unit 124 counts the period of the frame synchronization signal using the TSF clock. In addition, on the shutter glasses 13 side, the period of the frame synchronization signal generated by the signal generation unit 310 is counted in the control unit 306 using the TSF clock.

Thereafter, the communication unit 124 describes the period of the frame synchronization signal counted using the TSF clock in the synchronization packet and notifies the shutter glasses 13. On the shutter glasses 13 side, when the synchronization packet has been received, the periods of the frame synchronization signals, both of which are counted using the TSF clock, are compared with each other in the control unit 306, and the frequency of the frame synchronization signal generated by the signal generation unit 310 is synchronized on the basis of a difference between the two. More specifically, a frame difference between the two is input to an integrator as a frequency error value, and feedback control is performed on the VCO in the signal generation unit 310 to synchronize the frequency. As the integrator herein, a filter (LPF) having simple low-pass characteristics may be used. Alternatively, in consideration of obtaining excellent characteristics such as stability, static determinacy, and a steady-state error, a lag-lead filter or a filter having more complex characteristics may be used instead of the LPF.

Once the frame synchronization signal generated by the shutter glasses 13 is synchronized with the display apparatus 11 side, variation in the frame synchronization signal does not become large in a short period of time, and only variation in low-frequency components occurs. Although the timing at which the synchronization packet is transmitted from the display apparatus 11 might vary due to the CSMA/CA or the retransmission procedure, the band of a control loop for establishing the synchronization is not high, and therefore the variation in the timing at which the synchronization packet is transmitted does not affect the control.

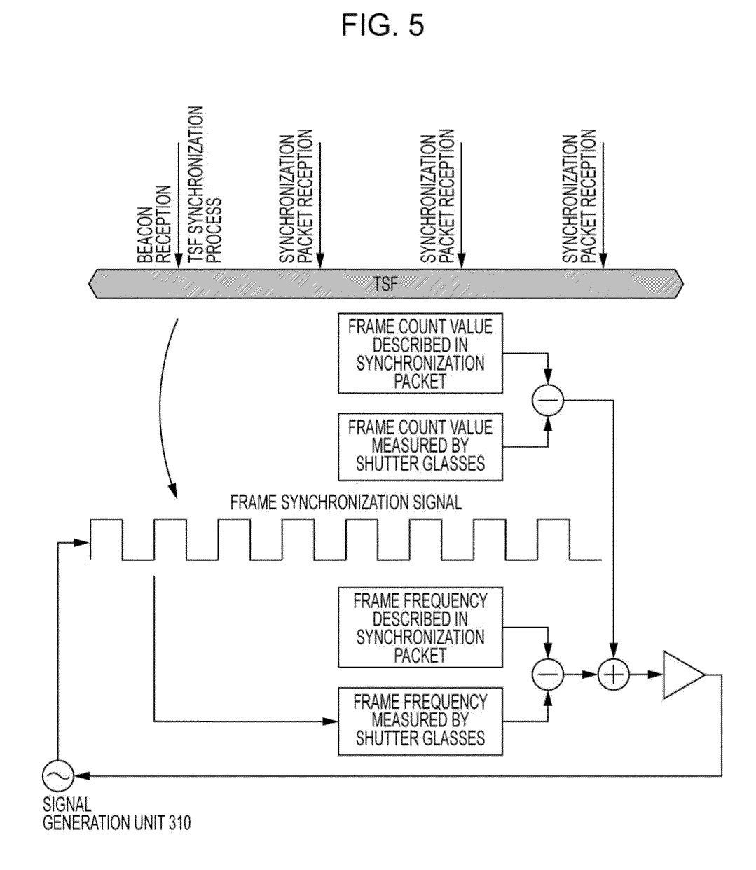

In FIG. 6, the transfer characteristics of a control system that controls the frequency synchronization of the VCO (described above) in the signal generation unit 310 using a frequency comparator are illustrated.

A clock that generates the frame synchronization signal on the display apparatus 11 side is denoted by R(S), and a clock that generates the frame synchronization signal on the shutter glasses 13 side is denoted by C(s). A difference between a count value (described in the synchronization packet) of the TSF clock that has measured the frame period on the display apparatus 11 side and a count value of the TSF clock that has measured the frame period on the shutter glasses 13 side is an output of the frequency comparator. When this output is input through a filter (LPF) as a control signal for the VCO in the signal generation unit 310, the transfer function of this closed loop can be obtained using the following expression (1).

[Math. 1]

KₚF(s)Kᵥ(R(s)−C(s))=C(s) (1)

By deforming the above expression (1), the following expression (2) is obtained.

$$\begin{matrix}[ Math . 2 ] & \\ \begin{matrix}{K}_{p} F ( s ) {K}_{v} R ( s ) = C ( s ) ( 1 + F ( s ) {K}_{v} ) \\ C ( s ) / R ( s ) = F ( s ) {K}_{p} {K}_{v} / ( 1 + F ( s ) {K}_{p} {K}_{v} )\end{matrix} \} & ( 2 )\end{matrix}$$

Therefore, the transfer function of the clock R(S) that generates the frame synchronization signal on the display apparatus 11 side and the clock C(s) that generates the frame synchronization signal on the shutter glasses 13 side is as indicated by the following expression (3). If this transfer function is stable, it is possible to synchronize the clocks between the display apparatus 11 and the shutter glasses 13.

[Math. 3]

C(s)/R(s)=F(s)KₚKᵥ/(1+F(s)KₚKᵥ) (3)

On the other hand, the phase synchronization is performed by comparing, between the display apparatus 11 and the shutter glasses 13, a count value (frame count value) until the frame synchronization signals transition for the first time after a beacon is transmitted, the count value being counted by the TSF clock. That is, a period until a next frame synchronization signal (the timing of an edge of the VSYNC) after the beacon is transmitted is counted using the TSF clock in each of the display apparatus 11 and the shutter glasses 13. However, a time difference between a beacon transmission timing on the display apparatus 11 side and a beacon reception timing on the shutter glasses 13 side is so small in terms of the phase synchronization that it can be neglected.

On the display apparatus 11 side, the frame synchronization signal generated by the timing control unit 126 is input to the communication unit 124, and after transmitting a beacon, the communication unit 124 counts a period until a next frame synchronization signal using the TSF clock. In addition, on the shutter glasses 13 side, after receiving the beacon using the communication unit 305, the control unit 306 counts a period until a next frame synchronization signal generated by the signal generation unit 310 using the TSF clock.

The communication unit 124 then describes the period until the next frame synchronization signal after the beacon is transmitted, the period being counted using the TSF clock, in the synchronization packet and notifies the shutter glasses 13. On the shutter glasses 13 side, upon receiving the synchronization packet, the control unit 306 compares the periods until the next frame synchronization signals after the beacon is transmitted and received, which are both counted using the TSF clocks, and since a difference between the two indicates a difference in phase, phase control of the frame synchronization signal generated by the signal generation unit 310 is performed. More specifically, the difference between the periods until the next frame synchronization signals after the beacon is transmitted and received is input to the integrator as a phase error value, and feedback control is performed on the VCO in the signal generation unit 310 to synchronize the phases. As the integrator herein, a filter (LPF) having simple low-pass characteristics may be used. Alternatively, in consideration of obtaining excellent characteristics such as stability, static determinacy, and a steady-state error, a lag-lead filter or a filter having more complex characteristics may be used instead of the LPF. In this control loop, not only a phase control mechanism but also the above-described phase control mechanism is included. Since both the phase control mechanism and the frequency control mechanism function, the frequency and the phase of the frame synchronization signal generated on the display apparatus 11 side can be reproduced by the shutter glasses 13. Needless to say, parameters can be independently adjusted in the frequency control and the phase control.

In the wireless network, the timing at which a beacon is transmitted might change in order to avoid a collision. As described above, according to the method for measuring the time elapsed since the beacon transmission timing on the display apparatus 11, a change in the beacon transmission timing does not have an effect. Similarly, since the time elapsed since the beacon reception timing is measured on the shutter glasses 13, too, a change in the beacon transmission timing on the display apparatus 11 does not have an effect.

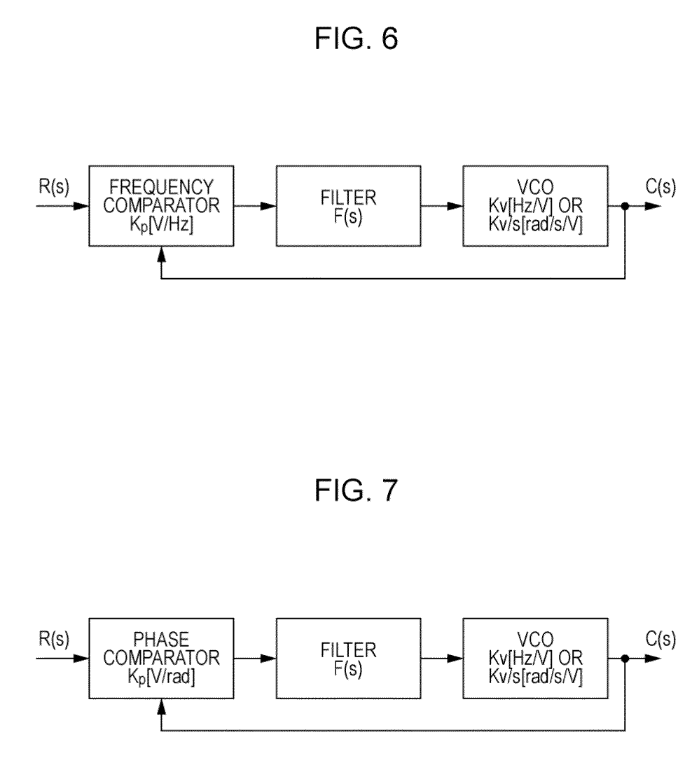

In FIG. 7, the transfer characteristics of a control system that controls the frequency synchronization of the VCO (described above) in the signal generation unit 310 using a phase comparator are illustrated.

A clock that generates a frame synchronization signal on the display apparatus 11 side is denoted by R(S), and a clock that generates a frame synchronization signal on the shutter glasses 13 side is denoted by C(s). A difference between a count value (described in the synchronization packet) of the TSF clock that has measured a time difference of the frame synchronization signal from the beacon transmission timing on the display apparatus 11 side and a count value of the TSF clock that has measured a time difference of the frame synchronization signal from the beacon transmission timing on the shutter glasses 13 side is an output of the phase comparator. When this output is input through a filter (LPF) as a control signal for the VCO in the signal generation unit 310, the transfer function of this closed loop can be obtained using the following expression (4).

[Math. 4]

KₚF(s)Kᵥ/s(R(s)−C(s))=C(s) (4)

By deforming the above expression (4), the following expression (5) is obtained.

$$\begin{matrix}[ Math . 5 ] & \\ \begin{matrix}{K}_{p} F ( s ) {K}_{v} / sR ( s ) = C ( s ) ( 1 + {K}_{p} F ( s ) {K}_{v} / s ) \\ C ( s ) / R ( s ) = ( F ( s ) {K}_{p} {K}_{v} / s ) / ( 1 + F ( s ) {K}_{p} {K}_{v} / s )\end{matrix} \} & ( 5 )\end{matrix}$$

Therefore, the transfer function of the clock R(S) that generates the frame synchronization signal on the display apparatus 11 side and the clock C(s) that generates the frame synchronization signal on the shutter glasses 13 side is as indicated by the following expression (6). If this transfer function is stable, it is possible to synchronize the clocks between the display apparatus 11 and the shutter glasses 13.

[Math. 6]

C(s)/R(s)=(F(s)KₚKᵥ/s)/(1+F(s)KₚKᵥ/s) (6)

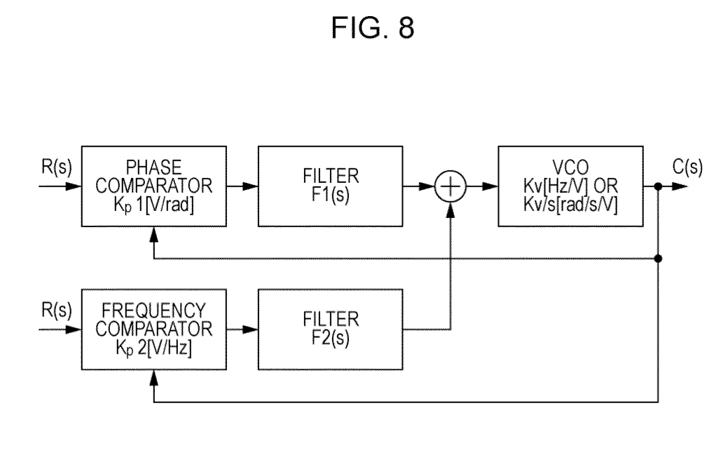

In addition, in FIG. 8, the transfer characteristics of a control system that controls the frequency synchronization of the VCO (described above) in the signal generation unit 310 using the frequency comparator and the phase comparator are illustrated. The transfer function of the control system that uses both the frequency comparator and the phase comparator is obtained using the following expression (7).

[Math. 7]

Kₚ₁F₁(s)Kᵥ/s(R(s)−C(s))+Kₚ₂F₂(s)Kᵥ(R(s)−C(s))=C(s) (7)

By deforming the above expression (7), the following expression (8) is obtained.

[Math. 8]

(Kₚ₁F₁(s)Kᵥ/s+Kₚ₂F₂(s)Kᵥ)R(s)=(Kₚ₁F₁(s)Kᵥ/s+Kₚ₂F₂(s)Kᵥ+1)C(s) (8)

Therefore, the transfer function of the clock R(S) that generates the frame synchronization signal on the display apparatus 11 side and the clock C(s) that generates the frame synchronization signal on the shutter glasses 13 side is as indicated by the following expression (9). If this transfer function is stable, it is possible to synchronize the clocks between the display apparatus 11 and the shutter glasses 13.

[Math. 9]

C(S)/R(S)=(F₁(s)Kₚ₁Kᵥ+F₂(s)Kₚ₂Kᵥs)/(F₁(s)Kₚ₁Kᵥ+(F₂(s)Kₚ₂Kᵥ+1)s) (9)

In the above expression (9), by changing the characteristics of low-pass filters F1(s) and F2(s), the percentages of two error detection components added can be changed.

After transmitting a synchronization packet in which the value obtained by counting the frame period using the TSF clock and the count value (frame count value) until the frame synchronization signal transitions for the first time are combined, the display apparatus 11 can stop the operation of the communication unit 124 for the remaining time and enter a power saving state.

On the shutter glasses 13 side, the content of description of the received synchronization packet is analyzed, and if the number of times that the frame period has been counted does not match the display apparatus 11, the frequency synchronization is established by adjusting the number of pieces of data regarding the frame period to a smaller value and redundant data is discarded. In addition, the phase synchronization need not be established every time a beacon is received. On the display apparatus 11 side, a period until the frame synchronization signal transitions for the first time is measured every time a beacon is transmitted, but on the shutter glasses 13 side, a period until the frame synchronization signal transitions for the first time after a beacon is received may be measured only when the phase synchronization is to be established. The display apparatus 11 performs measurement every time a beacon is received while the synchronization is to be established, but after the synchronization is established, the display apparatus 11 may intermittently perform synchronization control. In addition, the display apparatus 11 need not transmit a synchronization packet every time measurement is performed, but may transmit a synchronization packet once in a beacon period or once in a plurality of beacon periods while combining results of the measurement, and stop a communication function in other times to save power.

By using a wireless network for the communication between the display apparatus 11 and the shutter glasses 13 instead of infrared radiation, the user can establish synchronization even when the user does not face the front of the display apparatus 11, and the shutter glasses 13 are not restricted in terms of design. In addition, even if a plurality of display apparatuses are located close to one another, shutter glasses do not malfunction due to a signal received from another display apparatus.

It is to be noted that although the feedback control is performed by separately detecting the frequency error value and the phase error value in the examples of the configuration illustrated in FIGS. 5 and 8, the synchronization control can be performed as well by detecting and feeding back only the phase error value, which is the latter, because integrating the phase error corresponds to obtaining the frequency error value.

Finally, power control in the shutter glasses 13 is referred to. The power of the shutter glasses 13 needs to be saved since a battery is used as the main power supply. The intermittent reception operation of the communication unit 305 for not wasting power has already described. As another method for realizing power saving, a method for turning off the entirety or part of an electrical system while the shutter glasses 13 are not worn by the user is used.

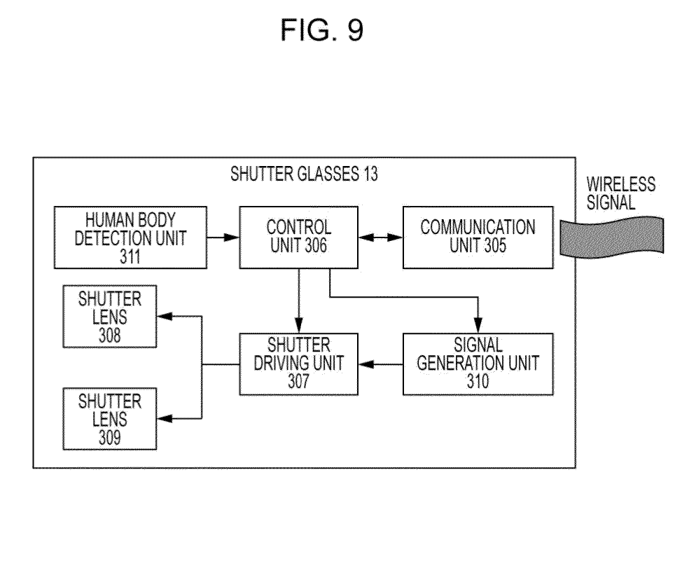

In FIG. 9, an example of the internal configuration of the shutter glasses 13 having a function of realizing power saving in accordance with whether or not the user wears the shutter glasses 13 is illustrated. A human body detection unit 311 detects whether or not the shutter glasses 13 are close to a human body, that is, whether or not the user wears the shutter glasses 13, and outputs a result of the detection to the control unit 306. The control unit 306 measures the time elapsed since the last time the human body detection unit 311 detected a human body, and after a lapse of a certain time, judges that the user is not using the shutter glasses 13. When the user is not using the shutter glasses 13, the control unit 306 automatically turns off the entirety or part of the electrical system.

The human body detection unit 311 is provided in a portion of the shutter glasses 13 with which the user can be in contact, such as temples or nose pads.

For example, the human body detection unit 311 may be configured by a mechanical switch provided in a nose pad portion. When the user wears the shutter glasses 13, the mechanical switch operates because of the weight of the shutter glasses 13 and a human body can be detected.

Alternatively, the human body detection unit 311 may be configured by a pair of electrodes provided in left and right temples or left and right nose pad portions and a measurement unit that measures electric resistance between the electrodes. The human body detection unit 311 can detect a human body when the measured resistance value is smaller than or equal to a certain value.

Alternatively, the human body detection unit 311 may be configured by one or more capacitance sensors provided in the left and right temples or the like. The human body detection unit 311 can detect a human body when all the capacitance sensors or one of the capacitance sensors have (has) detected a change in capacitance.

Alternatively, the human body detection unit 311 may be configured by one or more temperature sensors provided in the left and right temples or the like. The human body detection unit 311 can detect a human body when all the temperature sensors or one of the temperature sensors have (has) detected a temperature within a body temperature range.

Alternatively, the human body detection unit 311 may be configured by one or more oxygen concentration sensors or pulse sensors provided in the left and right temples or the like. The human body detection unit 311 can detect a human body when all the sensors or one of the sensors have (has) detected steady pulses. It is to be noted that, as a pulse sensor, an optical type configured by an infrared LED and a light receiving element, an electric resistance change type that reads from a minute change in current, or a pressure sensor type such as a piezoelectric element that reads a change in the pressure of blood vessels in temples may be used.

In addition, when the user wears the shutter glasses 13, the temples and the nose pad portion receive reaction force from the use's ears and nose, and, as a result, temple portions deform. The human body detection unit 311 may be configured by a pressure sensor that detects force applied due to the deformation of the temples.

### INDUSTRIAL APPLICABILITY

The present invention has been described above in detail with reference to the particular embodiment. However, it is obvious that one skilled in the art can modify or substitute the embodiment without deviating from the scope of the present invention.

The process for synchronizing the frequencies and the phases of the frame synchronization signals according to the embodiment described herein may be executed by either hardware or software, instead. When the process is to be realized by software, a computer program in which a processing procedure for the software is described in a computer-readable form may be installed on a certain computer and executed. Alternatively, this computer program may be incorporated into a product such as the shutter glasses.

In addition, although the embodiment described herein assumes a wireless network such as, for example, Wi-Fi or IEEE 802.15.4 as communication means for connecting the shutter glasses and the display apparatus, the scope of the present invention is not limited by a particular communication method. Even when another wireless communication technique or wired communication technique that executes packet communication between the shutter glasses and the display apparatus is applied, the synchronization of the frequencies and the phases of the frame synchronization signals can be accurately established, and the shutter glasses side can avoid crosstalk by controlling the open and close operation of the shutter lenses on the basis of the frame synchronization signal generated thereby.

In short, the present invention has been disclosed in the form of examples, and the content described herein is not to be interpreted in a limiting manner. In order to judge the scope of the present invention, the claims are to be referred to.

### REFERENCE SIGNS LIST

11 display apparatus
13 shutter glasses
120 left and right image signal processing unit
124 communication unit 124
126 timing control unit 126
130 gate driver
132 data driver
134 liquid crystal display panel
305 communication unit
306 control unit
307 shutter driving unit
308 shutter lens (for left eye)
309 shutter lens (for right eye)
310 signal generation unit
311 human body detection unit

1. An image display system comprising:
a display apparatus that includes a first communication unit which operates as an access point in a wireless network and executes packet communication and that displays an image for a left eye and an image for a right eye in time division on the basis of a first frame synchronization signal; and
shutter glasses that includes a second communication unit which operates as a terminal station under the access point in the wireless network and executes packet communication, a signal generation unit which generates a second frame synchronization signal, left and right shutter lenses, and a driving control unit which executes driving control on an open and close operation of the left and right shutter lenses on the basis of the second frame synchronization signal,
wherein a system clock is shared between the first communication unit and the second communication unit using a TSF (Timing Synchronization Function),
wherein the first communication unit transmits a beacon in a certain beacon period and also transmits a synchronization packet in which information for frequency synchronization and information for phase synchronization configured by values counted on the basis of the system clock are described, and
wherein the shutter lenses synchronize the second frame synchronization signal with a frequency of the first frame synchronization signal on the basis of the information for the frequency synchronization described in the received synchronization packet and also synchronizes the second frame synchronization signal with a phase of the first frame synchronization signal on the basis of the information for the phase synchronization.

2. A display apparatus comprising:
a display unit;
an image signal processing unit that processes an image signal;
a timing control unit that generates a frame synchronization signal for controlling a timing at which the image signal is displayed on a screen by the display unit; and
a communication unit that operates as an access point in a wireless network and that executes packet communication,
wherein the communication unit transmits a beacon in a certain beacon period and shares a system clock with a terminal station thereunder using a TSF, and
wherein the communication unit transmits a synchronization packet in which information for frequency synchronization and information for phase synchronization, which are used to synchronize the frame synchronization signal, configured by values counted on the basis of the system clock are described.

3. The display apparatus according to claim 2,
wherein the information for the frequency synchronization is a count value obtained by counting a period of the frame synchronization signal using the system clock, and
wherein the information for the phase synchronization is a count value obtained by counting a period until the frame synchronization signal transitions next time after a beacon transmission timing using the system clock.

4. Shutter glasses comprising:
left and right shutter lenses;
a signal generation unit that generates a frame synchronization signal;
a synchronization processing unit that synchronizes the frame synchronization signal;
a driving control unit that executes driving control on an open and close operation of the left and right shutter lenses on the basis of the frame synchronization signal; and
a communication unit that operates as a terminal station under an access point in a wireless network and that executes packet communication,
wherein the communication unit receives a beacon transmitted from the access point in a certain beacon period and shares a system clock with the access point using a TSF,
wherein a synchronization packet in which information for frequency synchronization and information for phase synchronization, which are used to synchronize frame synchronization signals in relation to a display apparatus that displays an image for a left eye and an image for a right eye on the basis of a frame synchronization signal, configured by values counted on the basis of the system clock are described is received by the communication unit, and
wherein the synchronization processing unit synchronizes frequencies of the frame synchronization signals on the basis of the information for the frequency synchronization described in the synchronization packet and also synchronizes phases of the frame synchronization signals on the basis of the information for the phase synchronization.

5. The shutter glasses according to claim 4,
wherein the information for the frequency synchronization is a count value obtained by counting a period of the frame synchronization signal on a display apparatus side using the system clock, and
wherein the synchronization processing unit counts a period of the frame synchronization signal generated by the signal generation unit using the system clock and synchronizes the frequencies using a difference from the count value of the information for the frequency synchronization as a frequency error value.

6. The shutter glasses according to claim 4,
wherein the information for the phase synchronization is a count value obtained by counting a period until the frame synchronization signal transitions next time after a beacon transmission timing on a display apparatus side using the system clock, and
wherein the synchronization processing unit counts a period until the frame synchronization signal generated by the signal generation unit transitions next time after a beacon reception timing of the communication unit using the system clock and synchronizes the phases using a difference from the count value of the information for the phase synchronization as a phase error value.
